(19) United States
(12) Patent Application Publication
(10) Pub. No.: US 2023/0117729 A1
(43) Pub. Date: Apr. 20, 2023

(54) A WATER DISTRIBUTION SYSTEM WITH HYGIENISATION CAPACITY

(71) Applicant: Orbital Systems AB, MALMÖ (SE)

(72) Inventors: Johanna DENNBO, Södra Sandby (SE); Mikael NILSSON, TRELLEBORG (SE); Patrik JONASSON, Vollsjö (SE)

(73) Assignee: Orbital Systems AB, MALMÖ (SE)

(21) Appl. No.: 17/799,392

(22) PCT Filed: Feb. 5, 2021
(86) PCT No.: PCT/SE2021/050084

§ 371 Date: Aug. 12, 2022

(30) Foreign Application Priority Data
Feb. 14, 2020 (SE) 2050159-9
Feb. 14, 2020 (SE) 2050160-7
Feb. 14, 2020 (SE) 2050161-5
Feb. 14, 2020 (SE) 2050162-3
Feb. 14, 2020 (SE) 2050163-1

(51) Int. Cl. F24D 17/00; E03C 1/02; E03C 1/044

(52) U.S. Cl. CPC F24D 17/0078; E03C 1/025; E03C 1/044; E03C 2201/40

(57) ABSTRACT

The present invention relates to a water distribution system with hygienisation capacity. According to a first aspect, the present invention describes a water distribution system (I) comprising a water supply, a heating source (IO0) or a point of inflow of externally heated water, at least one sensor measuring water quality, a flow path for water with a user outflow UO, and a control unit for operation of the water distribution system (1), said at least one sensor measuring water quality being connected to the control unit, wherein the water distribution system (I) comprises tubing in a tubing system where at least one portion of the tubing system in the water distribution system (1) comprises a tubing portion which is made of a plastic material comprising silver and/or zinc to provide an inner anti-biofilm of that tubing portion.

### FIELD OF THE INVENTION

The present invention relates to a water distribution system with hygienisation capacity.

### SUMMARY OF THE INVENTION ACCORDING TO A FIRST ASPECT THEREOF

The present invention is directed to a water distribution system comprising a water supply, a heating source or a point of inflow of externally heated water, at least one sensor measuring water quality, a flow path for water with a user outflow, and a control unit for operation of the water distribution system, said at least one sensor measuring water quality being connected to the control unit, wherein the water distribution system comprises tubing in a tubing system where at least one portion of the tubing system in the water distribution system comprises a tubing portion which is made of a plastic material comprising silver and/or zinc to provide an inner anti-biofilm of that tubing portion.

The present invention prevents fouling and growth build up on the tubing portion comprising the anti-biofilm material. This further provides the possibility of flushing the tubing to enable to remove any contaminants located inside the tubing. Such a procedure may be further complemented by a heat cycle and/or a cleaning in place procedure, if needed.

In relation to the expression “a heating source or a point of inflow of externally heated water” it should be noted that this implies that a system according to the present invention may comprise an internal heating source, such as a heater, or may instead have an inflow point where water heated outside the system is flowed into the system.

### SPECIFIC EMBODIMENTS OF THE FIRST ASPECT OF THE INVENTION

Embodiments of the present invention are clear from the enclosed claims and drawing.

According to one specific embodiment, said at least one tubing portion made of a plastic material comprising silver and/or zinc, to provide an inner anti-biofilm of that tubing portion, is arranged along the flow path provided subsequent to the heating source or the point of inflow of externally heated water and towards the user outflow. According to yet another embodiment, the tubing portion provided from the heating source or the point of inflow of externally heated water and along the entire length to the user outflow is made of a plastic material comprising silver and/or zinc to provide an inner anti-biofilm of that tubing portion. As hinted above, according to one specific embodiment of the present invention, the system comprises a heating source in the form of a heater.

Moreover, according to yet another specific embodiment, different tubing portions of the tubing in the tubing system in the water distribution system are made of a plastic material comprising silver and/or zinc to provide an inner anti-biofilm of those tubing portions. As an example, according to one embodiment several or all portions where plastic tubes are arranged, then these plastic tubes may comprise a plastic material comprising silver and/or zinc.

According to yet another embodiment of the present invention, the plastic material comprises zinc to provide an inner anti-biofilm property. In this specific case, then the material is more or less free from silver.

According to yet another specific embodiment of the present invention, the silver and/or zinc is extruded into the plastic material when the plastic material is produced, e.g. extruded into an inner layer which in turn is extruded as the inner layer of the plastic tubing.

Moreover, the plastic material may be several different types. According to one embodiment, the plastic material is polyamide, polyethylene, polypropylene, polyurethane or a combination thereof.

Furthermore, the present invention also refers to a water distribution system being a water recirculation system intended for recycling of water or discarding of water not suitable to recycle, said water recirculation system comprising a flow path for recirculation, and a sensor unit arranged for measurement of at least water quality, and wherein the sensor unit is connected to the control unit which decides if water should be recycled or discarded in a point of separation based on the measurement of the water quality, which water recirculation system comprises at least one water treating unit, preferably a UV treating unit, more preferably a filter unit and a UV treating unit, e.g. a filter unit and a combined UV treating unit and heater.

As notable above, the water recirculation system according to the present invention may comprise different types of water treating units. UV and heat are preferred technologies. Filtration may also be needed, either only in a drain unit, such as in a floor drain unit in a recirculating shower, or also in the flow path before a heater unit, e.g. before a combined UV and heater unit. Also in this case it should be said that the system according to the present invention may have only a point or several points of inflow of externally heated water instead of an internal heater.

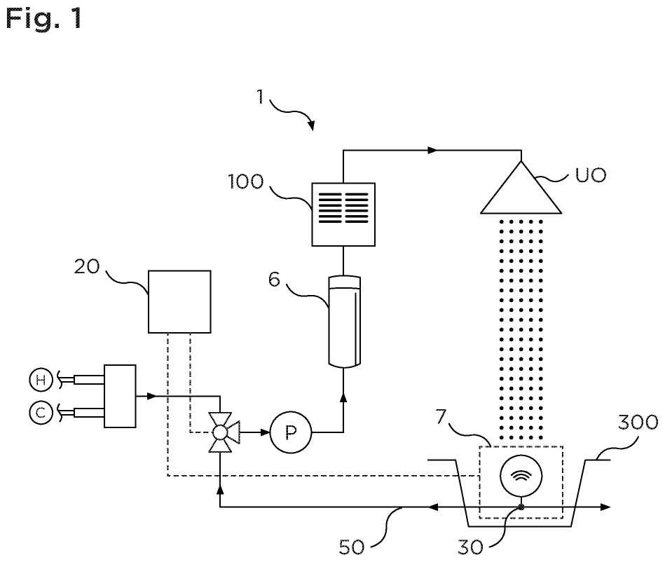

The water recirculation system, e.g. a recirculating shower as shown in FIG. 1, may of course also comprise several other units, such as other sensors, e.g. measuring water quality, temperature, water level and/or water flow. Such sensors, at least some of them, are suitably also connected to the control unit.

According to yet another specific embodiment of the present invention, the water recirculation system is a recirculating shower. One such alternative is shown in FIG. 1.

The type of recirculating shower may vary. According to one specific embodiment of the present invention, the recirculating shower comprises a wall box comprising at least one water treating unit, and where at least the tubing portion arranged from the wall box and towards the shower outflow is made of a plastic material comprising silver and/or zinc to provide an inner anti-biofilm of that tubing portion.

Furthermore, according to yet another specific embodiment of the present invention, the tubing portion arranged from a shower valve and until the shower outflow is made of a plastic material comprising silver and/or zinc to provide an inner anti-biofilm of that tubing portion.

Moreover, the present invention also refers to the use of tubing made of a plastic material comprising silver and/or zinc to provide an inner anti-biofilm of at least one tubing portion of the tubing in a tubing system, for the provision of anti-fouling in that tubing portion, in a water recirculation system as described above, such as in a water recirculation system, e.g. a recirculating shower.

### Drawings of a First Aspect of the Invention

In FIG. 1 there is shown a water recirculation system 1 in the form of a recirculating shower. The recirculating shower 1 comprises a water supply, seen as cold water inlet and hot water inlet combined in a mixer unit in this case, a heating source 100, at least one sensor measuring water quality which is shown in a sensor unit 7, a flow path for water with a user outflow UO, and a control unit 20 for operation of the recirculating shower 1. The sensor unit 7 is connected to the control unit 20. Moreover, in this case the water distribution system 1 is a recirculating shower having a drain unit 300 in which the sensor unit 7 is arranged. Moreover, a point of separation 30 is located in the drain unit 300 in this case. The control unit 20 makes a decision based on the water quality measurement if water should be recycled or discarded in the point of separation 30. In relation to FIG. 1 it should once again be said that the present invention also embodies a system having no internal heating source at all. In such a case, then hot water may be flown into the flow path a suitable place.

Furthermore, there is also provided a flow path for recirculation 50 in which water intended to be recirculated is flown.

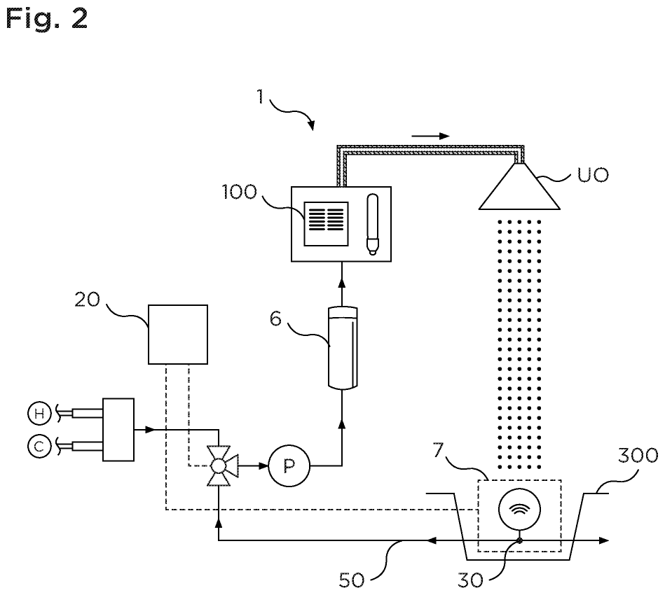

Moreover, the recirculating shower 1 comprises at least one valve, but several may be needed, and also a water treating unit 6. This may be in form of a filter which then is followed by a heater 100. Here, many different alternatives are possible. For instance, a filter 6 may be combined with a combined UV and heater unit 100. See for instance in FIG. 2 where there is provided both a heater and a UV treating unit (shown as a lamp). The water treating unit 6 may also be a UV treating unit which then is followed by a heater.

After the heater 100 there is provided tubing which is led to the user outlet UO, which in this case is a head shower unit. This passage, i.e. from the heater and until the user outlet, is one key passage according to the preset invention. At least part of this passage should comprise a tubing portion which is made of a plastic material comprising silver and/or zinc to provide an inner anti-biofilm of that tubing portion.

In FIG. 2 there is a similar system shown as in FIG. 1, however in this case the water treating unit is in the form a combined heater and UV treating unit. Moreover, as depicted with a visible thick wall, there is arranged an anti-biofilm material from the combined heater and UV treating unit and the entire passage to the user outlet UO.

### A Second Aspect of the Present Invention

The present invention, according to a second aspect thereof, is directed to a water distribution system comprising a water supply, a heating source or a point of inflow of externally heated water, at least one sensor measuring water quality, a flow path for water with a user outflow, and a control unit for operation of the water distribution system, said at least one sensor measuring water quality being connected to the control unit, wherein the water distribution system comprises tubing in a tubing system where at least one portion of the tubing system in the water distribution system comprises a tubing portion which is arranged with an electrical heating cable or which tubing portion is made of or is complemented with a heat conductive material, and is arranged to be heated up or to transfer heat to water.

According to this second aspect, the present invention provides a hygienisation solution to a water distribution system, e.g. a water recirculation system, such as a recirculating shower. As stated above, at least one portion of the tubing system in the water distribution system comprises a tubing portion which is arranged with an electrical heating cable or which is made of or is complemented with a heat conductive material, and is arranged to be heated up or to transfer heat to water. This implies that the water distribution system according to one embodiment of the present invention may be provided with an electrical cable. According to yet another specific embodiment, then the tubing portion is made of heat conductive material. Moreover, the tubing portion may also be complemented with a heat conductive material. These different alternatives are further discussed below. Regardless, it should be understood that the present invention embodies both alternatives where the actual tubing is heated up and alternatives where heat is transferred to heat up water inside of the tubing.

In relation to the expression “a heating source or a point of inflow of externally heated water” it should be noted that this implies that a system according to the present invention may comprise an internal heating source, such as a heater, or may instead have an inflow point where water heated outside the system is flowed into the system.

### Specific Embodiments of the Second Aspect of the Present Invention

Below some specific embodiment of the present invention are disclosed and discussed further.

According to one specific embodiment of the present invention, said at least one portion of the tubing system is arranged along the flow path provided subsequent to the heating source or the point of inflow of externally heated water and towards the user outflow.

According to yet another specific embodiment of the present invention, the tubing portion provided from a heating source, said heating source being in the form of a heater, and along the entire length to the user outflow is arranged with an electrical heating cable or is arranged with an electrical heating cable or which is made of or is complemented with a heat conductive material, and is arranged to be heated up or to transfer heat to water.

According to yet another embodiment of the present invention, said at least one portion of the tubing system in the water distribution system is arranged to be heated. In this case, the actual tubing is being heated up. It should be noted that the present invention provides embodiments where this is the case, but also embodiments where it is intended to heat up water standing inside of the tubing, which then in turn heats up the inside of the tubing.

According to yet another specific embodiment of the present invention, said at least one portion of the tubing system in the water distribution system is arranged to heat standing water inside of that portion of the tubing system.

According to one embodiment of the present invention, said at least one portion of the tubing system is arranged with an inner tube inside of the tubing, and wherein said the heating cable is arranged as an outer layer outside of the inner tube. Therefore, according to one specific embodiment of the present invention, said at least one portion of the tubing system comprises tubing arranged with a heating cable being part of a jacket cross section of the tubing. Furthermore, according to yet another embodiment of the present invention, the heating cable is provided directly outside of the inner tube of the tubing.

According to the present invention it is of interest to heat the inside of the tubing. As should be understood from above, this may be accomplished in different ways, such as by use of a material that is conductive as such, or to provide an electrical cable as such. In the case of a material that is conductive as such, then the tubing may be heated up. In some other embodiments according to the present invention where an electrical cable is provided then it may be of interest to heat up standing water inside of the tubing, which in turn heats up the actual tubing. As such, hot spots may be avoided, which otherwise is a risk in such a configuration. Moreover, in the case of providing an electrical cable, it is preferred that electrical units are not in a direct contact with water.

Moreover, according to another specific embodiment of the present invention, the heating cable is a self-regulating heating cable arranged as a jacket cross section of the tubing and along said at least one portion of the tubing system. One such alternative is shown in FIG. 5.

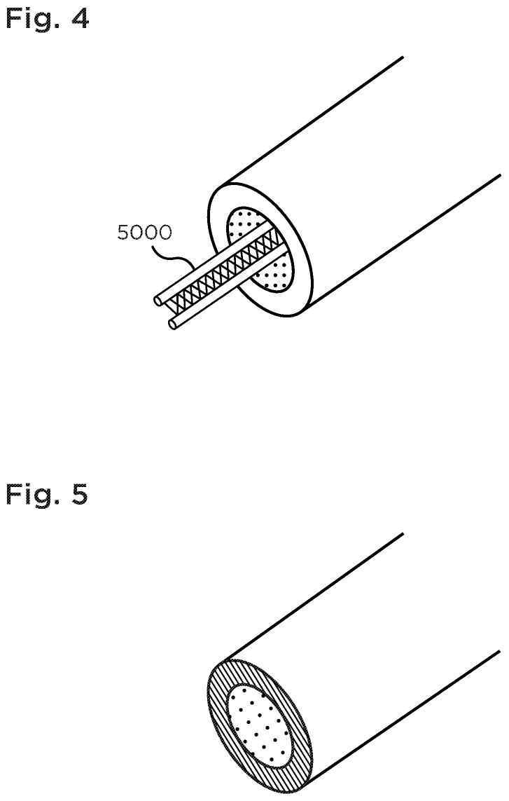

Furthermore, according to yet another embodiment of the present invention, said at least one portion of the tubing system is arranged as an electrical heating cable in itself. One such alternative is shown in FIG. 4.

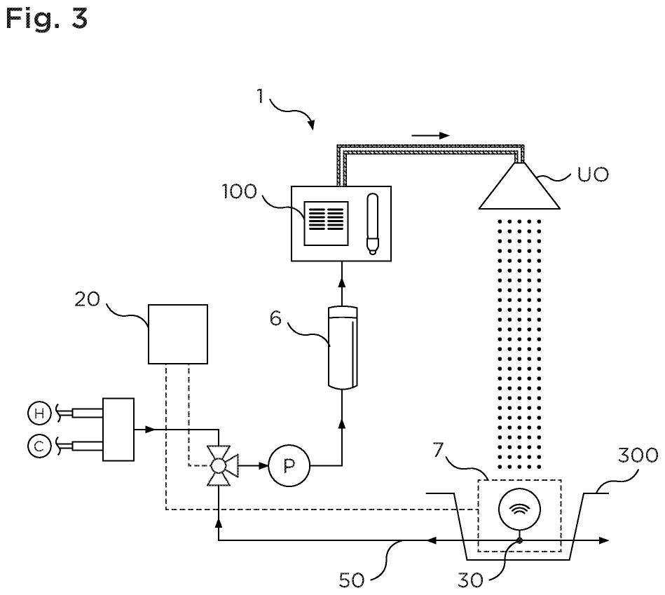

The present invention is especially directed to water recirculation applications. In line with this, according to one specific embodiment, the present invention is directed to a water distribution system according to the present invention, wherein the water distribution system is a water recirculation system intended for recycling of water or discarding of water not suitable to recycle, said water recirculation system comprising a flow path for recirculation, and a sensor unit arranged for measurement of at least water quality, and wherein the sensor unit is connected to the control unit which decides if water should be recycled or discarded in a point of separation based on the measurement of the water quality, which water recirculation system comprises at least one water treating unit, preferably a UV treating unit, more preferably a filter unit and a UV treating unit, e.g. a filter unit and a combined UV treating unit and heater. Example of such systems are shown in FIGS. 1 and 3.

According to one specific embodiment, the water recirculation system is a recirculating shower. Moreover, according to yet another specific embodiment of the present invention, the recirculating shower comprises a wall box comprising at least one water treating unit, and wherein at least the tubing portion arranged from the wall box and towards the shower outflow is arranged with an electrical heating cable or which is made of or is complemented with a heat conductive material, and is arranged to be heated up or to transfer heat to water.

According to one specific embodiment, the recirculating shower comprises a tubing portion arranged from a shower valve and until the shower outflow which is arranged with an electrical heating cable or which is made of or is complemented with a heat conductive material, and is arranged to be heated up or to transfer heat to water.

The present invention, according to this second aspect, is also directed to use of tubing arranged with an electrical heating cable arranged to be heated up or transfer heat to water, for the provision of heating of water inside of at least one tubing portion of the tubing in a tubing system, in a water distribution system according to the present invention, such as in a water recirculation system, e.g. a recirculating shower.

Furthermore, the present invention also refers to use of tubing which is made of or is complemented with a heat conductive material and is arranged to be heated up to provide ant-fouling of at least one tubing portion of the tubing in a tubing system, in a water recirculation system according to any of the preceding claims, such as in a water recirculation system, e.g. a recirculating shower.

The present invention is also directed a heating tube. Therefore, according to one specific embodiment of the present invention, the present invention is directed to a heating tube intended to be used for heating a liquid medium, such as water, said heating tube comprising an outer tubing and an inner tube, wherein said inner tube is arranged as a self-regulating heating cable arranged with one heating end arranged at and along an inner side of the inner tube and another heating end arranged at and along an outer side of the inner tube.

The inner tube is the one being heated up. This provides a hot inner surface in the tubing. The outer tube, however, is not heated up and instead functions as heat insulation.

### Drawings Related to a Second Aspect of the Present Invention

In FIG. 1 there is again shown a water recirculation system 1 in the form of a recirculating shower. This FIG. 1 may also depict one embodiment according to the second aspect of the present invention, and not only according to the first aspect of the present invention. The recirculating shower 1 comprises a water supply, seen as cold water inlet and hot water inlet combined in a mixer unit in this case, a heating source 100, at least one sensor measuring water quality which is shown in a sensor unit 7, a flow path for water with a user outflow UO, and a control unit 20 for operation of the recirculating shower 1. The sensor unit 7 is connected to the control unit 20. Moreover, in this case the water distribution system 1 is a recirculating shower having a drain unit 300 in which the sensor unit 7 is arranged. Moreover, a point of separation 30 is located in the drain unit 300 in this case. The control unit 20 makes a decision based on the water quality measurement if water should be recycled or discarded in the point of separation 30.

Furthermore, there is also provided a flow path for recirculation 50 in which water intended to be recirculated is flown.

Moreover, the recirculating shower 1 comprises at least one valve, but several may be needed, and also a water treating unit 6. This may be in form of a filter which then is followed by a heater 100. Here, many different alternatives are possible. For instance, a filter 6 may be combined with a combined UV and heater unit 100. See for instance in FIG. 3 where there is provided both a heater and a UV treating unit (shown as a lamp). The water treating unit 6 may also be a UV treating unit which then is followed by a heater.

After the heater 100 there is provided tubing which is led to the user outlet UO, which in this case is a head shower unit. This passage, i.e. from the heater and until the user outlet, is one key passage according to the preset invention. At least part of this passage should comprise a tubing portion which is made of a plastic material comprising silver and/or zinc to provide an inner anti-biofilm of that tubing portion.

In FIG. 3 there is a similar system shown as in FIG. 1, however in this case the water treating unit is in the form a combined heater and UV treating unit. Moreover, as depicted with a visible thick wall, there is arranged tubing portion which is arranged with an electrical heating cable or which tubing portion is made of or is complemented with a heat conductive material, and is arranged to be heated up or to transfer heat to water, which tubing portion is arranged from the combined heater and UV treating unit and the entire passage to the user outlet UO.

In FIG. 4 there is shown one tubing portion according to one specific embodiment of the present invention, seen in a cross sectional view. In this case the tubing is arranged as with an electrical heating cable 5000.

Moreover, according to another specific embodiment of the present invention, the heating cable is a self-regulating heating cable arranged as a jacket cross section of the tubing and along said at least one portion of the tubing system. One such alternative is shown in FIG. 5.

### A Third Aspect of the Present Invention

The present invention, according to a third aspect thereof, relates to a water distribution system comprising a water treatment system.

According to this aspect, the present invention is directed to a water distribution system comprising a water supply, a heating source or a point of inflow of externally heated water, at least one sensor measuring water quality, a flow path for water with a user outflow, and a control unit for operation of the water distribution system, said at least one sensor measuring water quality being connected to the control unit, wherein the water distribution system comprises a UV treating system and/or an ultrasound treating system arranged to provide UV light and/or ultrasound along the flow path provided subsequent to the heating source or subsequent to the point of inflow of externally heated water and towards the user outflow.

In relation to the expression “a heating source or a point of inflow of externally heated water” it should be noted that this implies that a system according to the present invention may comprise an internal heating source, such as a heater, or may instead have an inflow point where water heated outside the system is flowed into the water distribution system.

### Specific Embodiments of the Third Aspect of the Present Invention

Below, some specific embodiment of the third aspect of the present invention are disclosed and explained further.

According to one specific embodiment of the present invention, the UV treating system and/or an ultrasound treating system is arranged to provide UV light and/or ultrasound along a substantial length of the flow path provided subsequent to the heating source or subsequent to the point of inflow of externally heated water and to the user outflow, preferably the full length of the flow path provided subsequent to the heating source or subsequent to the point of inflow of externally heated water and to the user outflow.

As should be understood from above, according to this third aspect, the present invention is directed to a water distribution system comprising a UV treating system or an ultrasound treating system, or both. According to one specific embodiment of the present invention, the water distribution system comprises a UV treating system. Moreover, according to yet another specific embodiment of the present invention, the water distribution system comprises a UV treating system comprising several UV treating units. Furthermore, according to yet another specific embodiment of the present invention, at least one UV treating unit is a LED UV treating unit. The system may also comprise both LED UV treating units and other UV treating unit types. For instance, in a recirculating shower according to the present invention may comprise a regular UV treating unit arranged in close proximity to a heater may be combined with one or more LED UV treating unit arranged in e.g. a handheld shower unit. In this context it may also be mentioned that according to yet another specific embodiment of the present invention, the UV treating system comprises several UV treating units, and where at least one UV treating unit is arranged to provide UV light along the flow path provided subsequent to the heating source or subsequent to the point of inflow of externally heated water and towards the user outflow and wherein at least one UV treating unit is arranged inside of the flow path of a handheld shower unit. The UV treating unit combined with LED UV treating units may ensure a full UV exposure to UV light inside the tubing system so that there are not any positions inside of the tubing which are not UV treated where there is an evident risk of growth.

Furthermore, and in line with the above, according to one specific embodiment of the present invention, according to this third aspect thereof, the UV treating system comprises several UV treating units, and wherein at least two of the UV treating units are provided at different positions in the water distribution system.

Moreover, according to yet another embodiment, the UV treating system is arranged to provide UV light along a substantial length of the flow path provided subsequent to the heating source or subsequent to the point of inflow of externally heated water and to the user outflow by incorporating UV reflecting units into the flow path.

Furthermore, according to yet another specific embodiment of the present invention, the UV treating system is arranged to provide UV light along a substantial length of the flow path provided subsequent to the heating source or subsequent to the point of inflow of externally heated water and to the user outflow by incorporating a UV light transferring/(conductive) material into the flow path. According to one embodiment, the UV light transferring material comprises FEP (fluorinated ethylene propylene) and/or optical Teflon (optical polytetrafluoroethylene), e.g. FEP Teflon in combination. Moreover, according to one embodiment, the UV light transferring material comprises FEP (fluorinated ethylene propylene) with coated aluminum. This alternative combines different features, such as a strong UV light conductive material with an aluminium coating, the latter ensuring that the UV light does not travel through the transparent FEP material but instead along the tubing flow path.

According to another embodiment of the present invention, the water distribution system comprises an ultrasound treating system. According to one embodiment, the ultrasound treating system is arranged to provide ultrasound along a substantial length of the flow path provided subsequent to the heating source or subsequent to the point of inflow of externally heated water and to the user outflow by incorporating an ultrasound transferring material and/or ultrasound reflecting units into the flow path. This type of arrangement preferably also ensures to minimize pits and unnecessary corners etc. which may “kill” the ultrasound and prevent it from travelling through the flow path.

According to yet another specific embodiment of the present invention, there is arranged a UV absorbing unit and/or an ultrasound absorbing unit in a close proximity to the user outflow and inside the tubing of the flow path. This absorbing unit ensures to stop the liberation of the UV light and/or ultrasound out from the user outlet. Suitably, such absorbing unit(s) is arranged just at the end of the user outflow.

According to one specific embodiment of the present invention, the UV treating system and/or the ultrasound treating system is arranged to provide UV light and/or ultrasound along the entire length of the flow path provided subsequent to the heating source or subsequent to the point of inflow of externally heated water and towards the user outflow. Again, a full exposure is preferable, however with full absorption just at or before the user outflow so neither UV light nor ultrasound can reach a user.

According to yet another embodiment of the present invention, the water distribution system is a water recirculation system intended for recycling of water or discarding of water not suitable to recycle, said water recirculation system comprising a flow path for recirculation, and a sensor unit arranged for measurement of at least water quality, and wherein the sensor unit is connected to the control unit which decides if water should be recycled or discarded in a point of separation based on the measurement of the water quality, which water recirculation system comprises at least one water treating unit, preferably a UV treating unit, more preferably a filter unit and a UV treating unit, e.g. a filter unit and a combined UV treating unit and heater. It should be understood that the UV treating unit here can be arranged to ensure a full exposure of UV light from the heater and to the user outlet. Different alternatives therefore have been discussed above.

Furthermore, it should be noted that a water distribution system according to the present invention ma of course comprise several other units, such as valve(s), additional sensors, such as relating to measurement of water quality, level, flow, temperature, pressure etc.

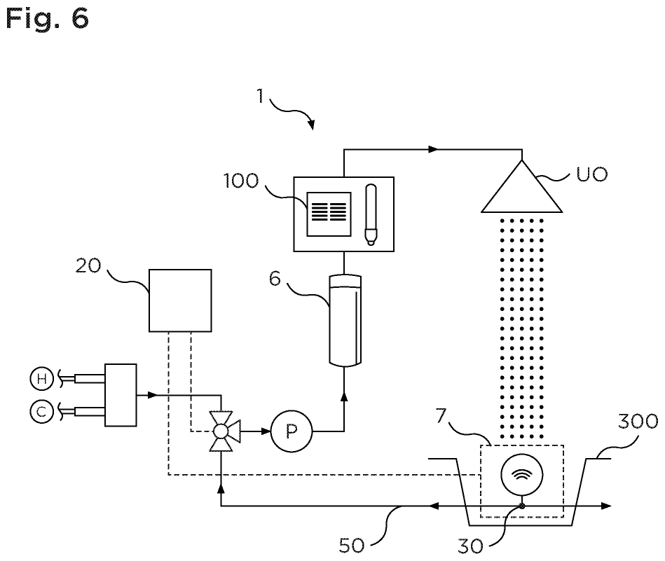

Moreover, the water recirculation system may be a recirculating shower. One such alternative is shown in FIG. 6. According to one specific embodiment of the present invention, a recirculating shower according to above comprises a wall box comprising at least one water treating unit, and wherein the UV treating system and/or the ultrasound treating system is arranged to provide UV light and/or ultrasound along at least the tubing arranged from the wall box and towards the shower outflow. Furthermore, according to yet another embodiment, the UV treating system and/or the ultrasound treating system is arranged in the recirculating shower to provide UV light and/or ultrasound along at least the tubing arranged from a shower valve and until the shower outflow.

### Drawings Relating to a Third Aspect of the Present Invention

In FIG. 6 there is shown a water recirculation system 1 in the form of a recirculating shower. The recirculating shower 1 comprises a water supply, seen as cold water inlet and hot water inlet combined in a mixer unit in this case, a heating source 100, the heating source 100 being optional and may instead be a point of inflow of externally heated water, at least one sensor measuring water quality which is shown in a sensor unit 7, a flow path for water with a user outflow UO, and a control unit 20 for operation of the recirculating shower 1. The sensor unit 7 is connected to the control unit 20. Moreover, in this case the water distribution system 1 is a recirculating shower having a drain unit 300 in which the sensor unit 7 is arranged. Moreover, a point of separation 30 is located in the drain unit 300 in this case. The control unit 20 makes a decision based on the water quality measurement if water should be recycled or discarded in the point of separation 30.

Furthermore, there is also provided a flow path for recirculation 50 in which water intended to be recirculated is flown.

Moreover, the recirculating shower 1 comprises at least one valve, but several may be needed, and also a water treating unit 6. This may be in form of a filter which then is followed by a heater 100. Here, many different alternatives are possible. For instance, a filter 6 may be combined with a combined UV and heater unit. The water treating unit 6 may also be a UV treating unit which then is followed by a heater.

The recirculating shower 1 according to this embodiment comprises a UV light generator (lamp) that ensures UV light (UV C) to travel from the generator to the user outlet. In this case, the UV lamp is arranged in a unit together with the heater 100 (again optional). Moreover in this case there is arranged a UV conductive/transferring material which ensures that the UV light reaches the full flow path until the user outflow (UO). Moreover, in close proximity to the user outflow there may be provided one or more UV light absorbing units ensuring that no UV light comes out from the user outflow. The same type of thinking is possible for the present invention if an ultrasound generator is arranged instead if a UV light generator.

Furthermore, one or more LED UV units may be used. These may function as a complement or be the actual UV source(s). These can run continuously, which is not the case fur some other types of UV sources.

The intensity used and reaching the user outlet is an important question. The intensity used in the source needs to be high enough, but should also be combined with features ensuring that UV light with enough intensity reaches an area close to the user outflow. Moreover, and as said, also the wavelength used is of interest. According to one specific embodiment of the present invention, the UV wavelength used is in the range of 240-280 nm.

### A Fourth and Fifth Aspect of the Invention

According to a fourth aspect of the present there is provided a water recirculation system intended for recycling of water or discarding of water not suitable to recycle, said water recirculation system comprising a flow path for recirculation, a pump, and a sensor unit arranged for measurement of at least water quality, and wherein the sensor unit is connected to a control unit which decides if water should be recycled or discarded in a point of separation based on the measurement of the water quality, said water recirculation system also comprising an ozone treatment unit.

According to one preferred embodiment, the ozone treatment unit is arranged for hygienisation of at least a part of a flow path for recirculation from a user outlet and going back through the flow path for recirculation. According to one embodiment, the ozone treatment unit is arranged for the production of drinkable water.

According to one specific embodiment of the present invention, the water recirculation system also comprises an ozone destruction unit arranged subsequent to the ozone treatment unit in process terms. In this case, this solution according to the ozone treatment route of the present invention ensures both the incorporation of an ozone treatment unit as well as an ozone destruction unit. As such, water flow in the flow path for recirculation may be treated with ozone to kill bacteria and minimize growth of bacteria, however subsequently the remaining ozone is destructed so that it does not reach the intended outflow of the recirculation path. This is of course important in e.g. a recirculating shower to minimize the risk of any ozone flowing out from a shower head, the shower head being the end unit of the flow path for recirculation.

In relation to the present invention it should be noted that it is possible to implement in different types of technical applications. For instance, and as should be understood from above, a water recirculation system intended for production of drinkable water is one such possible application.

Furthermore, the present invention may also involve other technical features and starting points than an ozone treatment unit, either in itself or as a complement. One such possible technology is ultra clean water.

Based on the above, according to one specific embodiment of the present invention, the ozone treatment unit and ozone destruction unit are arranged as final operation units in the flow path for recirculation. This embodiment implies that for instance in a recirculating shower, at least the ozone destruction unit is arranged in the final part of the flow path for recirculation, i.e. before the shower head. As such, the risk of ozone flowing out from the shower head is avoided. If the ozone destruction unit is placed close to the outflow of the flow path for recirculation, then ozone may treat the water flow in the entire flow path for recirculation up until the ozone destruction unit.

According to one specific embodiment of the present invention, the ozone destruction unit is a light unit, such as an UV unit. Also other types of ozone destruction units are possible, such as units enabling catalytic destruction. Such a catalytic destruction unit may e.g. be built on manganese dioxide and/or copper oxide technology. Other possible examples are combinations of different technologies. Units incorporating activated carbon or ultrasound or supplying energy of some form may also be possible according to the present invention.

Moreover, according to yet another embodiment, the water recirculation system also comprises a heating source. This ensures water to be heated inside of the system. It should, however, be noted that also heating outside of the system according to the present invention is totally possible. In such a case, then heated water is flown into the system to be mixed with/flown into water being recirculated in the system.

Furthermore, according to a fifth aspect of the present invention, the purpose mentioned above is achieved by a water recirculation system intended for recycling of water or discarding of water not suitable to recycle, said water recirculation system comprising a flow path for recirculation, a pump and a sensor unit arranged for measurement of at least water quality, and wherein the sensor unit is connected to a control unit which decides if water should be recycled or discarded in a point of separation based on the measurement of the water quality, said water recirculation system also comprising a hypochlorite treatment unit.

Also in this case, according to one specific embodiment the hypochlorite treatment unit is arranged for hygienisation of at least a part of a flow path for recirculation from a user outlet and going back through the flow path for recirculation. Furthermore, according to yet another embodiment, the hypochlorite treatment unit is arranged for the production of drinkable water.

Also in the case, the system may comprise a heating source. Again, the system according to the present invention may also be arranged not to include a heating unit/heater. In such a case, then heated water is flown into the system according to the present invention.

According to one specific embodiment of the present invention, the system comprises a heating unit/heater. According to one specific embodiment of the present invention, the water recirculation system comprises an ozone treatment unit arranged before a heating source in process terms, and/or wherein the water recirculation system comprises a hypochlorite treatment unit arranged subsequent to a heating source in process terms.

In general, water recirculation systems incorporating an ozone generation unit are disclosed. For instance, in WO2009/147647 there is disclosed a water recirculating shower which may comprise a disinfection unit. This disinfection unit may be a UV lamp or may be an oxidant or ozone generator, a chemical or bactericide dispenser or a heater. Furthermore, in WO2017/099663 there is also disclosed a water recirculation apparatus which may comprise a light unit which uses light with a wavelength so that ozone is produced. This ozone containing water is then used for disinfection e.g. for anti-microbial effect, chemical degradation of surfactants or perfume substances, and/or cleaning parts of the apparatus.

Furthermore, to use ozone or chlorine in water disinfection operations, also together with e.g. UV, is well-established today.

In relation to the above it should be mentioned that the present invention according to some of the embodiments disclosed above provides a water recirculation system which provides treatment of water, by incorporating at least two water treatment units, to increase the water quality and in which system an ozone generating unit and/or hypochlorite generating unit is optimally positioned with reference to other components in the system. In the case of only an ozone treatment unit, then the present invention suitably provides an ozone destruction unit positioned so that there is a high effect of the ozone treating effect but at the same time minimizes the risk of any ozone flowing out from the water recirculation system. Regardless, the present invention provides an arrangement where an ozone treatment unit and/or a hypochlorite treatment unit are provided in suitable position in a water recirculation system.

Moreover, to enable optimal disinfection effect in a system also comprising a heater, which in itself is incorporated not only to provide enough user temperature but also to enable disinfecting heating of the recirculating water, then the ozone treatment unit is either arranged before this heating unit, i.e. in accordance with one of the aspects of the present invention, or after the heater, however in that case there must be another ozone destructing/trapping unit arranged subsequent to the ozone treating unit. In this first case, then the heater may act as the ozone destruction unit. As ozone is broken down at elevated temperatures, e.g. at 35° C. and above and with total degradation at temperatures above 50° C., the heater may function as the ozone destructing unit. Therefore, regardless of aspect or embodiment of the present invention, when an ozone treatment unit is incorporated, then some kind of ozone destruction unit should be incorporated subsequent to the ozone treatment unit. As mentioned above, either this ozone destruction unit is in form of a heater or another type.

In relation to the above aspect it may also be mentioned that the operation of an ozone treating unit in a water recirculation system according to the present invention depends on the type of ozone destruction unit in the system. To mention some possible examples, in the case of the heater being the ozone destruction unit, then it is important to ensure that the temperature is high enough when ozone is introduced in the flow path for recirculation. If other types of ozone destruction units are used, then it is not important to ensure a high temperature in the water to destruct the ozone. In a recirculating shower according to the present invention this implies that if another type of ozone destruction unit than a heater is incorporated, then the ozone treatment may be used during a regular showering, that is when the temperature of the water is below 40° C. If the heater is intended as the ozone destruction unit then it is important to perform the ozone destruction during other sequences, such as a heating of the flow path of recirculation to a temperature above 50° C. This also opens up for performing the ozone treatment and the heating in different sequences, however not during regular showering.

According to another aspect of the present invention then a hypochlorite treatment unit is incorporated. In such a case, then the hypochlorite treatment unit is preferably arranged subsequently to the heating unit, such as arranged in accordance to the present invention. As most of all water recirculation systems, such as e.g. a recirculating shower, comprises subsequent tubing from the heating unit to the user outflow, such as a shower head in case of a shower, this part of the recirculation path is very sensitive with regards to growth of bacteria and the like. Therefore, when a hypochlorite unit is incorporated this is preferably arranged so as to provide a chlorine disinfection of this last portion of the recirculation path. This is try also for the case when is ensured to act also on this last portion.

### Specific Embodiments of the Fourth and Fifth Aspects of the Invention

Below specific embodiments of the present invention according to these aspects are provided and discussed.

According to one specific embodiment of the present invention, the water recirculation system comprises an ozone treatment unit arranged before the heating source in process terms.

With reference to the ozone route according to the present invention, there are also other aspects to consider. One is where to produce the ozone and another one is retention time for the water and ozone to ensure enough ozone treatment. In this context, according to one specific embodiment of the present invention, the ozone treatment unit comprises a reaction chamber and an ozone reactor for the formation of ozone. The ozone reactor should provide enough ozone production and together with the ozone reaction chamber ensure enough retention time etc. to provide for enough ozone in relation to the water recirculation flow. In accordance to this, according to one embodiment of the present invention, the ozone treatment unit is arranged to provide an amount of ozone in relation to the water flow of at least 1.5 mg*min/liter.

As hinted above, the water recirculation system according to the present invention may comprise multiple water treating units, i.e. three or more. According to one specific embodiment of the present invention, the water recirculation system also comprises a water treating unit in the form of a light unit, such as a UV unit, e.g. a UV lamp, UV LED unit or other type of LED unit. According to one specific embodiment of the present invention, the additional water treating unit is a UV unit arranged subsequent to an ozone treatment unit. As mentioned, such a UV unit then works as an ozone destruction unit as UV light degrades remaining ozone. This may be of interest at times when ozone is produced, and the heater is not run at elevated temperatures. As such, possible remaining ozone is then degraded by the UV treatment. In relation to the UV treating unit it should be mentioned that this unit may be arranged in direct connection to the heater. Therefore, according to one specific embodiment of the present invention, a heating source and a UV unit is arranged in a combined UV/heater unit. This implies that the heater and UV unit in fact is arranged in one and the same unit. It should be noted that the heater unit in operation may then also function as an ozone trap, such as mentioned above. As mentioned above, this depends on the actual temperature inside of the heater. With an incorporated UV unit, this functions as an ozone trap, regardless of the temperature inside of the actual heater.

Moreover, according to one specific embodiment of the present invention, the water recirculation system also comprises a water purification unit in the form of a filter. It should be noted that the water recirculation system according to the present invention in fact may comprise different types of filters, such as a pre-filter positioned in an inflow end of the recirculation path or a micro-filter intended to separate particulate material from the recirculation flow. Also combinations thereof, i.e. with several filters, are totally possible according to the present invention. According to one specific embodiment of the present invention, the ozone treatment unit is positioned after the filter. As mentioned above, a filter is intended to block and separate off particulate material, such as material of micro-size or so, and a subsequent ozone treating unit may then act on bacteria or the like passing through the filter.

According to yet another specific embodiment of the present invention, the filter is a ceramic filter which is the input unit for ozone being produced in the ozone reactor of the ozone treatment unit. This type of filter may be regarded as a “perpetual” filter. Moreover, such a ceramic filter is back-flushable. Based on the information above with reference to material possible to separate off in a filter and not, it may be of interest to combine such a filter with the ozone treatment according to the present invention. As such, the water flowing through the filter is treated with ozone at the same time or directly after the filtration.

According to another specific embodiment of the present invention, the water recirculation system also comprises a second heating source. Such a second heating source may be an external heating source which heats water which in turn is heat exchanged against the recirculating water. Examples are an LPG heater or solar panels.

Moreover, the point of separation may be provided at different positions according to the present invention. According to one specific embodiment of the present invention, the point of separation is arranged in a drain. Such a drain may e.g. be arranged as the drain of a recirculating shower floor. Moreover, the drain may also be arranged at different positions in the water recirculation device. Moreover, a heat exchange arrangement may also be provided in such a drain or close to the point of separation. In such a case water sent to waste may arranged to heat fresh cold water flown into the water recirculation system.

Furthermore, according to yet another specific embodiment of the present invention, the sensor unit comprises at least one conductivity sensor and/or at least one turbidity sensor. It should be noted that many different types of sensors are possible according to the present invention, also dependent on which types of units are incorporated in the system. For example, if a UV unit is incorporated in the system then a UV sensor may be provided. Such a sensor may act towards being a functionality sensor for the UV unit. In case of conductivity sensors, these may act on different aspects, such as water quality or water level, both minimum level and maximum level. Many other types of sensors are also possible, such as IR sensors, near-IR sensors or a camera/image sensor.

One or more sensors may also be arranged in the system according to the present invention in relation to the ozone treating unit. For example, sensors ensuring functionality of the ozone treating unit may be incorporated, suitable showing or ensuring the production of ozone. Ozone measurement sensors may also be possible.

The present invention is also directed to a method for operation of a water recirculation system comprising an ozone treatment unit according to the present invention, wherein a sequence of heating water in the water recirculation system and a sequence of ozone treatment of water in the water recirculation system are performed at different times. As hinted above, this is of interest to ensure that the water is not kept at a too high temperature when the ozone treatment is performed on the water flow.

### Drawings Relating to a Fourth and Fifth Aspect of the Invention

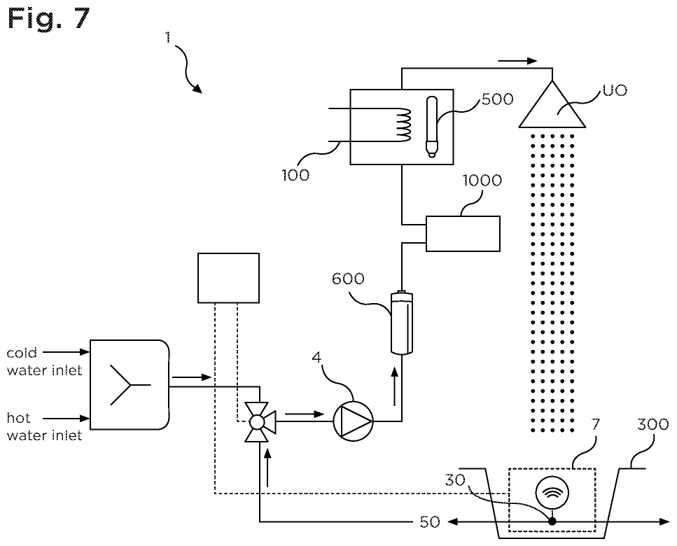

In FIG. 7 there is shown one specific embodiment of the present invention. This embodiment of the present invention relates to a water recirculation system 1 which in this case is in the form of a shower. It should be noted that other alternatives of water recirculation devices are of course totally possible according to the present invention, e.g. sinks with faucets for the production of drinkable water. Moreover, in this case the recirculation system 1 comprises an ozone treatment unit 1000 which in this specific case is positioned before a heating source 100 in process terms. In this regard it should be noted that the heated water flown into the system 1 may be heated outside of the system 1.

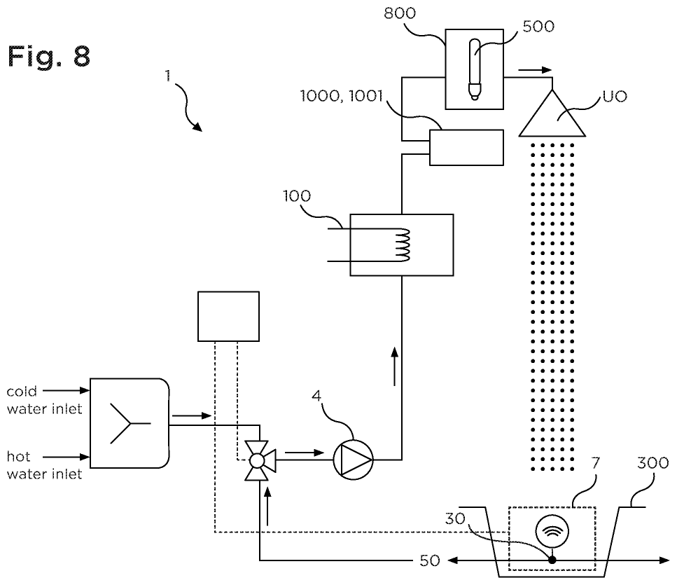

Furthermore, it should also be noted that a hypochlorite treatment unit 1001 may be incorporated instead of an ozone treatment unit 1000 (see FIG. 8). Such hypochlorite treatment unit 1001 is suitably arranged subsequent to a heating source 100 in process terms when such heating source 100 is incorporated in the system 1. Also systems comprising both an ozone treatment unit arranged before the heating source 100 and a hypochlorite treatment unit arranged subsequent to the heating source are totally possible according to the present invention.

Returning to FIG. 7 the water recirculation system 1 comprises a flow path for recirculation 50 and a pump 4. Moreover, the heating source 100 may supply hot water heated from another type of external heating sources, such as an LPG heater or solar panels or other sources. Furthermore, the water recirculation system 1 also comprises a sensor unit 7 arranged for measurement of at least water quality, and wherein the sensor unit 7 is connected to a control unit which decides if water should be recycled or discarded in a point of separation 30 based on the measurement of the water quality. The sensor unit 7, in this case arranged in a drain 300, comprises at least one sensor which detects the water quality and sends a signal to a control unit (see connection as dotted lines), which makes a decision whether to separate off water, i.e. discard it because of low quality, or to send it in the flow path of recirculation 50 and by opening the valve then also enable to recirculate it in the entire flow path of recirculation 50 and reuse the water in the shower again. It should be noted that the sensor unit 7 may comprise several sensors, also in other parts of the system.

Moreover, the water recirculation system 1 comprises a water inlet, cold and warm side, which is led to a mixer. The clean water is flown into the water recirculation system via a valve and is then pumped through the water recirculation system 1 and out through the shower head. In this case, the water recirculation system 1 also comprises a water treating unit in the form of a light unit 500, suitably a UV lamp or LED UV unit. In this specific case, the UV unit is arranged together with the heater in one and the same unit, i.e. in a combined UV/heater unit.

Furthermore, this specific embodiment also includes a water purification unit in the form of a filter 600. In this specific case, the filter 600 is positioned before the ozone treating unit, but the filter 600 may also be integrated together in the ozone treating unit, as is explained above in the description.

Moreover, it should be noted that these units, i.e. a light unit and a filter, are totally optional according to the present invention. Moreover, there may also be arranged different types of filter units in the water recirculation system 1. For instance, a rough filter for collection of hair or large particulate material may be arranged in the drain 300, totally independent on if a micro filter unit 600 or a similar filter unit is implemented in the water recirculation system 1 or not.

In FIG. 8 there is shown yet another specific embodiment of the present invention. In this case the water recirculation system 1 is also in form of a shower. As notable, according to this specific embodiment there is no filter provided in the system, however this is of course totally possible. Moreover, in this case, the ozone treatment unit 1000 and/or a hypochlorite treatment unit 1001 is arranged subsequent to a heating source 100. Furthermore, in the case of an ozone treatment unit 1000 there may also be an ozone destruction unit 800 incorporated, which in this case comprises a light unit 500, arranged subsequent to the ozone treatment unit 1000 in process terms.

### A Sixth Aspect of the Present Invention

According to this sixth aspect, the present invention relates to a water distribution system with closed loop capabilities. According to this aspect, the present invention relates to a water distribution system comprising a water supply, a heating source or a point of inflow of externally heated water, a sensor unit with at least one sensor measuring water quality, an outflow path for water with a user outflow UO, and a control unit for operation of the water distribution system, said at least one sensor in measuring water quality being connected to the control unit, said water distribution system being a water recirculation system intended for recycling of water or discarding of water not suitable to recycle, said water recirculation system comprising a flow path for recirculation, and wherein the sensor unit is connected to the control unit which decides if water should be recycled or discarded in a point of separation based on the measurement of the water quality, wherein a flow redirecting unit is arranged to enable to provide a closed loop of at least part of the outflow path and the flow path for recirculation and at which time a free outflow from the user outflow UO is disabled so that water cannot flow out from the user outflow UO the regular direction.

The expression “flow redirecting unit is arranged to enable to provide a closed loop of at least part of the outflow path and the flow path for recirculation and at which time a free outflow from the user outflow UO is disabled so that water cannot flow out from the user outflow UO the regular direction” implies that the water distribution system according to the present invention has the capability of ensuring to recirculate water without any risk of flowing out from the user outlet. This further implies that hot water can be recirculated in a closed loop of the water distribution system without any risk of harming a user.

The flow redirecting unit can come in several different forms according to the present invention. It may be that the actual flow directing unit is a user outflow unit, e.g. a handheld shower, which is dockable into a docking unit. Different possible such solutions and docking units are further described below. Moreover, it may also be that the flow directing unit is another type of user outflow unit which has multiple capabilities, such as be rotated to change the flow direction. Furthermore, the flow directing unit can also be a separated connectable unit, which is connected from a user outflow and directly to the recirculation loop.

Moreover, in relation to the expression “a heating source or a point of inflow of externally heated water” it should be noted that this implies that a system according to the present invention may comprise an internal heating source, such as a heater, or may instead have an inflow point where water heated outside the system is flowed into the system.

By ensuring a closed loop according to the sixth aspect of the present invention, water may be flown through a heater, when such is included, and be heated without any risk for a user. The water can be pasteurized by being heated up, such as to a temperature above 55° C., e.g. up to a temperature in the range of 65-80° C., to kill bacteria, for instance in the outflow path for water arranged subsequent to a heater. Moreover, by providing such hot water in this part, then the tubing etc. in this part can be decontaminated from growth and fouling on that tubing. It should be noted that this tubing part is difficult to hygienize without an evident risk for a user in systems existing today. The present invention enables this by establishing a closed loop in at least part of the recirculation loop and at least in the flow path provided from the heater and out to the user outflow.

### Specific Embodiments of the Sixth Aspect of the Invention

Below, some specific embodiments of the sixth aspect of the present invention are disclosed and further explained.

According to one specific embodiment of the present invention, the water distribution system is a water recirculation system comprising at least one water treating unit, preferably a UV treating unit, more preferably a water treating system comprising both a filter unit and a UV treating unit, e.g. a filter unit and a combined UV treating unit and a heater.

As mentioned above, the flow redirecting unit may be provided in different forms and types. According to one embodiment of the present invention, a stationary outflow unit is the flow directing unit and comprises a direct recirculation to redirect the water flow from the user outflow and to direct recirculation. This capability is suitable automatically driven, i.e. when the water distribution unit, such as a recirculating shower, detects the need for or is programmed to perform a hot water decontamination, then the stationary outflow, e.g. a top shower unit, is automatically changed from a user outflow mode to direct recirculation mode. This enables hot water to be recirculated from the heater and in the user outflow path and from the user outflow through a recirculation loop and back over the heater, i.e. without flowing out from the user outflow.

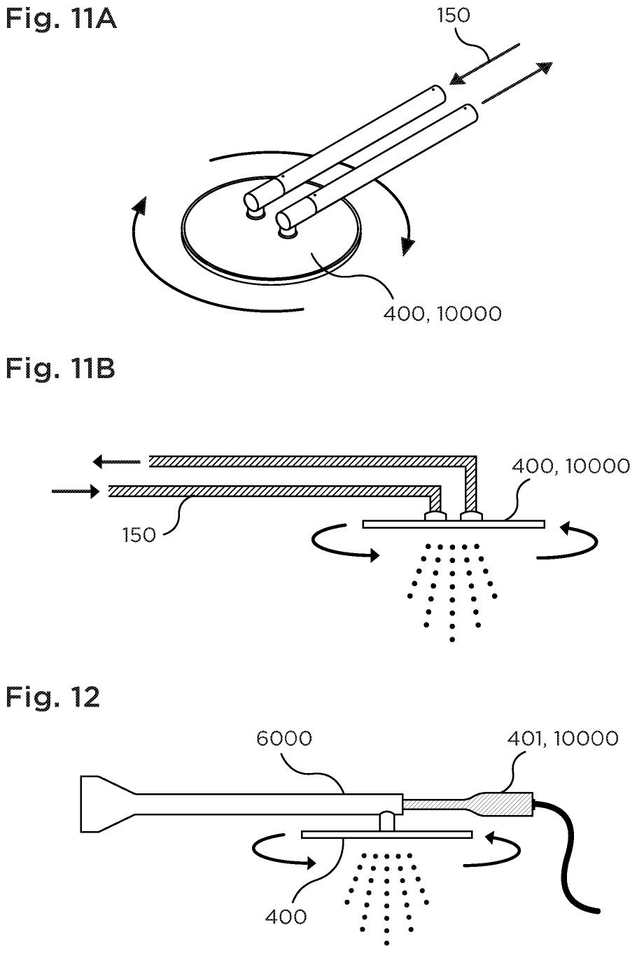

This type of solution may also be provided as a user-driven mechanical solution according to the present invention. Therefore, according to one specific embodiment of the present invention, a stationary outflow unit is a rotary unit with at least two positions, said stationary outflow unit therefore being the flow directing unit, one first position being for regular user outflow and another position being in an at least partly rotated state and with direct recirculation. See FIGS. 11a and 11b for one example according to the present invention.

According to yet another specific embodiment of the sixth aspect of the present invention, based also on a user-driven mechanical solution, a stationary outflow unit is a rotary unit with at least two positions, said stationary outflow unit therefore being the flow directing unit, one first position being for regular user outflow and another position being pivoted downwards to dock into a docking unit. Both alternatives presented above implies that the user will change the stationary outflow unit from a user outflow mode to a recirculation mode, in the first case by twisting the stationary outflow unit into another flow route and in the second alternative by pivoting the stationary outflow unit down into a docking unit and thus alternative flow route.

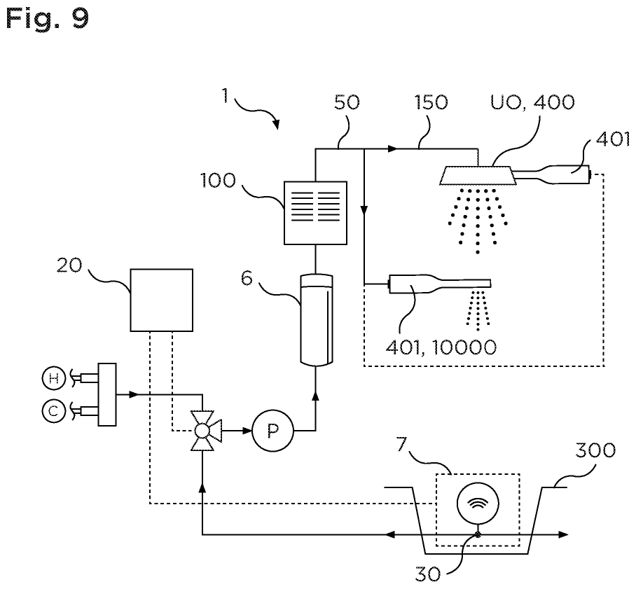

The water distribution unit according to the present invention may also have other types of arrangements. In line with this, according to one specific embodiment of the present invention, the water distribution system comprises a docking unit into which a handheld outflow unit is dockable, said handheld outflow unit being the flow directing unit, and wherein a dockable state provides a water flow connection between the handheld outflow unit and the docking unit and provides a closed loop of at least part of the outflow path and the flow path for recirculation is established. Certain embodiments for dockable handheld outflow units presented in the figures are shown in FIGS. 9, 10 and 12.

Furthermore, according to one specific embodiment of the present invention, a stationary outflow unit is the docking station. On such alternative is shown in FIG. 12 where the top shower unit is the docking station.

To provide one example of the above, according to one specific embodiment of the sixth aspect of the present invention the handheld outflow unit is a handheld shower unit. Moreover, such a handheld shower unit may then be dockable into a top unit, such as a top docking unit. Therefore, according to one specific embodiment, the stationary outflow unit is a top shower unit which is a docking unit (see e.g. FIG. 12), and wherein the handheld outflow unit is a handheld shower unit which is dockable into the docking unit for establishment of water flow connection. Furthermore, a top docking unit may be arranged in the same unit as a top shower unit. By docking the handheld shower unit into the top docking unit, then the flow direction is amended so that a closed loop is established.

Moreover, it should be noted that the handheld shower unit in fact instead may be connectable into another type of docking unit, which connection also establishes a closed loop inside the water distribution unit and wherein the heater unit is arranged as being a part of that closed loop.

Furthermore, also other possibilities are possible according to the present invention. According to one specific embodiment, the flow redirecting unit is in the form of a connectable unit to connect the user outflow with the flow path for recirculation. This connection may be obtainable in different ways according to the present invention, such as e.g. by a unit which connects a top unit, such as a top shower unit to a different flow route, which in turn then establishes the changed flow route and closed loop.

As hinted above, according to one specific embodiment, the water distribution unit is a water recirculation unit. According to yet another specific embodiment, the water distribution system is a recirculating shower. Furthermore, and in line with the above, the handheld outflow unit may be a handheld shower unit.

Moreover, according to yet another specific embodiment, the water distribution system is a recirculating shower comprising a wall box comprising at least one water treating unit, and which wall box comprises a docking unit into which a handheld shower is dockable for establishment of water flow connection.

### Drawings Relating to a Sixth Aspect of the Present Invention

In FIG. 9 there is shown a water distribution system 1 in the form of a recirculating shower. The recirculating shower 1 comprises a water supply, seen as cold water inlet and hot water inlet ((C) and (H)) combined in a mixer unit in this case, a heating source 100 or a point of inflow of externally heated water, at least one sensor measuring water quality which is shown in a sensor unit 7, a flow path for water with a user outflow UO, and a control unit 20 for operation of the recirculating shower 1. The sensor unit 7 is connected to the control unit 20. Moreover, in this case the water distribution system 1 is a recirculating shower having a drain unit 300 in which the sensor unit 7 is arranged. Moreover, a point of separation 30 is located in the drain unit 300 in this case. The control unit 20 makes a decision based on the water quality measurement if water should be recycled or discarded in the point of separation 30.

Furthermore, there is also provided a flow path for recirculation 50 in which water intended to be recirculated is flown. Moreover, a water treating unit 6, which may be a UV treating unit, e.g. arranged in a combined UV and heater unit, but may also be a filter. Furthermore, bot a filter and UV unit may also be provided in the water distribution system 1.

Furthermore, in FIG. 9 there is also shown that the handheld shower unit 401 may function as a flow redirecting unit 10000 by being connected to the top shower/stationary outflow unit 400 functioning also as a docking unit 6000, to provide a closed loop of at least part of the outflow path 150 and the flow path for recirculation 50 and at which time a free outflow from the user outflow UO is disabled so that water cannot flow out from the user outflow UO the regular direction.

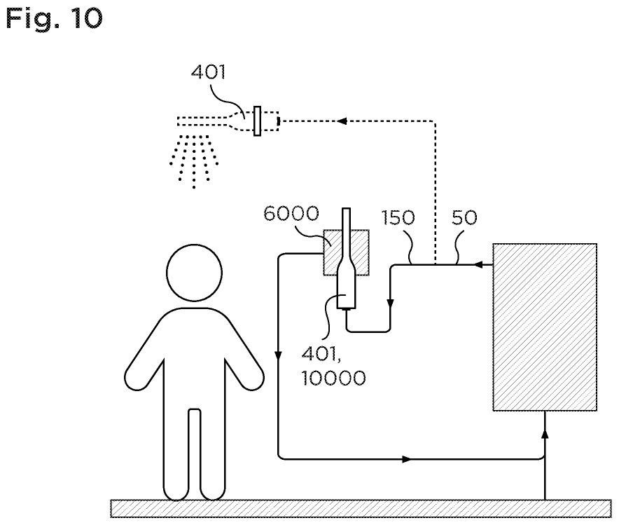

In FIG. 10 there is shown another embodiment of the present invention. In this case the handheld shower unit 401 also functions as the flow redirecting unit 10000, however it is adapted to be inserted into a docking unit 6000 when the closed loop is intended for decontamination of that loop. Moreover. The handheld shower unit 401 is also arranged to function as the actual top shower, e.g. by being connected to a receiver unit, e.g. with a fastening function by clicking the handheld shower into this unit or a crutch unit or the like.

In FIGS. 11A and 11B there is shown yet another flow redirecting unit 10000 according to the present invention where the stationary outflow unit/top shower unit 400 is the flow redirecting unit 10000. The top shower unit 400 is rotatable to ensure either a flow direction for showering or for redirecting the flow to create the closed loop. Therefore, the top shower unit 400 may be said to be a rotary unit with at least two positions, one first position being for regular user outflow and another position being in an at least partly rotated state and with direct recirculation mode.

In FIG. 12 there is shown yet another embodiment of the present invention. In this case, the alternatives shown in FIGS. 10 and 11A/11B are combined. In this case there is arranged both a handheld shower 401 and a top shower/stationary outflow unit 400. In this case the top shower unit 400 functions as the docking unit 6000. When the handheld shower 401 is connected to the docking unit 6000 it is intended for the handheld shower to function as the flow redirecting unit 10000 to create the closed loop. To ensure that the water flows the right way, there may be a mechanical activation needed by rotating the top shower unit 400. It should be noted that this may be obtained by other means, e.g. by a valve changed by user activation.

It should be noted that all of the aspects according to the present invention relates to water recirculating devices. Furthermore, the different aspects according to the present invention may be combined in many ways, in fact more or less in any suitable way.

### Clauses—a Second Aspect of the Present Invention

1. A water distribution system (1) comprising a water supply, a heating source (100) or a point of inflow of externally heated water, at least one sensor measuring water quality, a flow path for water with a user outflow (UO), and a control unit for operation of the water distribution system (1), said at least one sensor measuring water quality being connected to the control unit, characterized by that the water distribution system (1) comprises tubing in a tubing system where at least one portion of the tubing system in the water distribution system (1) comprises a tubing portion which is arranged with an electrical heating cable (5000) or which tubing portion is made of or is complemented with a heat conductive material, and is arranged to be heated up or to transfer heat to water.
2. The water distribution system (1) according to claim 1, wherein said at least one portion of the tubing system is arranged along the flow path provided subsequent to the heating source (100) or the point of inflow of externally heated water and towards the user outflow (UO).
3. The water distribution system (1) according to claim 1, wherein the tubing portion provided from a heating source (100), said heating source (100) being in the form of a heater, and along the entire length to the user outflow (UO) is arranged with an electrical heating cable (5000) or which tubing portion is made of or is complemented with a heat conductive material, and is arranged to be heated up or to transfer heat to water.
4. The water distribution system (1) according to any of claims 1-3, wherein said at least one portion of the tubing system in the water distribution system (1) is arranged to be heated.
5. The water distribution system (1) according to any of claims 1-3, wherein said at least one portion of the tubing system in the water distribution system (1) is arranged to heat standing water inside of that portion of the tubing system.
6. The water distribution system (1) according to any of claims 1-5, wherein said at least one portion of the tubing system comprises tubing arranged with a heating cable being part of a jacket cross section of the tubing.
7. The water distribution system (1) according to claim 6, wherein the heating cable is provided directly outside of an inner tube of the tubing.
8. The water distribution system (1) according to claim 6 or 7, wherein the heating cable is a self-regulating heating cable arranged as a jacket cross section of the tubing and along said at least one portion of the tubing system.
9. The water distribution system (1) according to any of claims 1-5, wherein said at least one portion of the tubing system is arranged as an electrical heating cable (5000) in itself.
10. The water distribution system (1) according to any of the preceding claims, wherein the water distribution system (1) is a water recirculation system intended for recycling of water or discarding of water not suitable to recycle, said water recirculation system (1) comprising a flow path for recirculation (50), and a sensor unit (7) arranged for measurement of at least water quality, and wherein the sensor unit (7) is connected to the control unit which decides if water should be recycled or discarded in a point of separation (30) based on the measurement of the water quality, which water recirculation system comprises at least one water treating unit (6), preferably a UV treating unit, more preferably a filter unit and a UV treating unit, e.g. a filter unit and a combined UV treating unit and heater.
11. The water distribution system (1) according to claim 10, wherein the water recirculation system is a recirculating shower.
12. The water distribution system (1) according to claim 11, which recirculating shower comprises a wall box comprising at least one water treating unit, and wherein at least the tubing portion arranged from the wall box and towards the shower outflow is arranged with an electrical heating cable (5000) or which is made of or is complemented with a heat conductive material, and is arranged to be heated up or to transfer heat to water.
13. The water distribution system (1) according to claim 11 or 12, in which recirculating shower the tubing portion arranged from a shower valve and until the shower outflow is arranged with an electrical heating cable (5000) or which is made of or is complemented with a heat conductive material, and is arranged to be heated up or to transfer heat to water.
14. Use of tubing arranged with an electrical heating cable (5000) arranged to be heated up or transfer heat to water, for the provision of heating of water inside of at least one tubing portion of the tubing in a tubing system, in a water distribution system (1) according to any of claims 1-13, such as in a water recirculation system, e.g. a recirculating shower.
15. Use of tubing which is made of or is complemented with a heat conductive material and is arranged to be heated up to provide ant-fouling of at least one tubing portion of the tubing in a tubing system, in a water recirculation system (1) according to any of claims 1-13, such as in a water recirculation system, e.g. a recirculating shower.
15. Heating tube intended to be used for heating a liquid medium, such as water, said heating tube comprising an outer tubing and an inner tube, wherein said outer tube is arranged as a self-regulating heating cable arranged with one heating end arranged at and along an inner side of the outer tube and another heating end arranged at and along an outer side of the outer tube.

### Clauses—a Third Aspect of the Present Invention

1. A water distribution system (1) comprising a water supply, a heating source (100) or a point of inflow of externally heated water, at least one sensor measuring water quality, a flow path for water with a user outflow (UO), and a control unit for operation of the water distribution system (1), said at least one sensor measuring water quality being connected to the control unit, characterized by that the water distribution system (1) comprises a UV treating system and/or an ultrasound treating system arranged to provide UV light and/or ultrasound at least along the flow path provided subsequent to the heating source (100) or subsequent to the point of inflow of externally heated water and towards the user outflow (UO).
2. The water distribution system (1) according to claim 1, wherein the UV treating system and/or an ultrasound treating system is arranged to provide UV light and/or ultrasound along a substantial length of the flow path provided subsequent to the heating source (100) or subsequent to the point of inflow of externally heated water and to the user outflow (UO), preferably the full length of the flow path provided subsequent to the heating source (100) and to the user outflow (UO).
3. The water distribution system (1) according to claim 1 or 2, wherein the water distribution system (1) comprises a UV treating system comprising several UV treating units.
4. The water distribution system (1) according to claim 3, wherein at least one UV treating unit is a LED UV treating unit.
5. The water distribution system (1) according to claim 3 or 4, wherein the UV treating system comprises several UV treating units, and wherein at least two of the UV treating units are provided at different positions in the water distribution system.
6. The water distribution system (1) according to any of claims 3-5, wherein the UV treating system comprises several UV treating units, and wherein at least one UV treating unit is arranged to provide UV light along the flow path provided subsequent to the heating source (100) or subsequent to the point of inflow of externally heated water and towards the user outflow (UO) and wherein at least one UV treating unit is arranged inside of the flow path of a handheld shower unit.
7. The water distribution system (1) according to any of the preceding claims, wherein the UV treating system is arranged to provide UV light along a substantial length of the flow path provided subsequent to the heating source (100) or subsequent to the point of inflow of externally heated water and to the user outflow (UO) by incorporating UV reflecting units into the flow path.
8. The water distribution system (1) according to any of the preceding claims, wherein the UV treating system is arranged to provide UV light along a substantial length of the flow path provided subsequent to the heating source (100) or subsequent to the point of inflow of externally heated water and to the user outflow (UO) by incorporating a UV light transferring material into the flow path.
9. The water distribution system (1) according to claim 8, wherein the UV light transferring material comprises FEP (fluorinated ethylene propylene) and/or optical Teflon.
10. The water distribution system (1) according to claim 8 or 9, wherein the UV light transferring material comprises FEP (fluorinated ethylene propylene) with coated aluminum.
11. The water distribution system (1) according to claim 1 or 2, wherein the water distribution system (1) comprises an ultrasound treating system.
12. The water distribution system (1) according to claim 11, wherein the ultrasound treating system is arranged to provide ultrasound along a substantial length of the flow path provided subsequent to the heating source (100) or subsequent to the point of inflow of externally heated water and to the user outflow (UO) by incorporating an ultrasound transferring material and/or ultrasound reflecting units into the flow path.
13. The water distribution system (1) according to any of the preceding claims, wherein there is arranged a UV absorbing unit and/or an ultrasound absorbing unit in a close proximity to the user outflow (UO) and inside the tubing of the flow path.
14. The water distribution system (1) according to any of the preceding claims, wherein the UV treating system and/or the ultrasound treating system is arranged to provide UV light and/or ultrasound along the entire length of the flow path provided subsequent to the heating source (100) or subsequent to the point of inflow of externally heated water and towards the user outflow (UO).
15. The water distribution system (1) according to any of the preceding claims, wherein the water distribution system (1) is a water recirculation system intended for recycling of water or discarding of water not suitable to recycle, said water recirculation system (1) comprising a flow path for recirculation (50), and a sensor unit (7) arranged for measurement of at least water quality, and wherein the sensor unit (7) is connected to the control unit which decides if water should be recycled or discarded in a point of separation (30) based on the measurement of the water quality, which water recirculation system comprises at least one water treating unit (6), preferably a UV treating unit, more preferably a filter unit and a UV treating unit, e.g. a filter unit and a combined UV treating unit and heater.
16. The water distribution system (1) according to claim 15, wherein the water recirculation system is a recirculating shower.
17. The water distribution system (1) according to claim 16, which recirculating shower comprises a wall box comprising at least one water treating unit, and wherein the UV treating system and/or the ultrasound treating system is arranged to provide UV light and/or ultrasound along at least the tubing arranged from the wall box and towards the shower outflow.
18. The water distribution system (1) according to claim 16 or 17, in which recirculating shower the UV treating system and/or the ultrasound treating system is arranged to provide UV light and/or ultrasound along at least the tubing arranged from a shower valve and until the shower outflow.

### Clauses—a Fourth and a Fifth Aspect of the Present Invention

1. A water recirculation system (1) intended for recycling of water or discarding of water not suitable to recycle, said water recirculation system (1) comprising a flow path for recirculation (50), a pump (4), and a sensor unit (7) arranged for measurement of at least water quality, and wherein the sensor unit (7) is connected to a control unit which decides if water should be recycled or discarded in a point of separation (30) based on the measurement of the water quality, said water recirculation system (1) being characterized by that the water recirculation system (1) also comprises an ozone treatment unit (1000).
2. The water recirculation system (1) according to claim 1, wherein the ozone treatment unit (1000) is arranged for hygienisation of at least a part of a flow path for recirculation (50) from a user outlet (UO) and going back through the flow path for recirculation (50).
3. The water recirculation system (1) according to claim 1 or 2, wherein the ozone treatment unit (1000) is arranged for the production of drinkable water.
4. The water recirculation system (1) according to any of claims 1-3, wherein the water recirculation system (1) also comprises an ozone destruction unit (800) arranged subsequent to the ozone treatment unit (1000) in process terms.
5. The water recirculation system (1) according to any of claims 1-4, wherein the water recirculation system (1) also comprises a heating source (100).
6. The water recirculation system (1) according to any of the preceding claims, wherein the ozone treatment unit (1000) and ozone destruction unit (800) are arranged as final operation units in the flow path for recirculation (50).
7. The water recirculation system (1) according to any of claims 4-6, wherein the ozone destruction unit (800) is a light unit (500).
8. A water recirculation system (1) intended for recycling of water or discarding of water not suitable to recycle, said water recirculation system (1) comprising a flow path for recirculation (50), a pump (4) and a sensor unit (7) arranged for measurement of at least water quality, and wherein the sensor unit (7) is connected to a control unit which decides if water should be recycled or discarded in a point of separation (30) based on the measurement of the water quality, said water recirculation system (1) being characterized by that the water recirculation system (1) also comprises a hypochlorite treatment unit (1001).
9. The water recirculation system (1) according to claim 8, wherein the hypochlorite treatment unit (1001) is arranged for hygienisation of at least a part of a flow path for recirculation (50) from a user outlet (UO) and going back through the flow path for recirculation (50).
10. The water recirculation system (1) according to claim 8 or 9, wherein the hypochlorite treatment unit (1001) is arranged for the production of drinkable water.
11. The water recirculation system (1) according to any of claims 7-10, wherein the water recirculation system (1) comprises an ozone treatment unit arranged before a heating source (100) in process terms, and/or wherein the water recirculation system (1) comprises a hypochlorite treatment unit (1001) arranged subsequent to a heating source (100) in process terms.
12. The water recirculation system (1) according to any of the preceding claims, wherein the ozone treatment unit (1000) comprises a reaction chamber and an ozone reactor for the formation of ozone.
13. The water recirculation system (1) according to any of the preceding claims, wherein the ozone treatment unit (1000) is arranged to provide an amount of ozone in relation to the water flow of at least 1.5 mg*min/liter.
14. The water recirculation system (1) according to any of the preceding claims, wherein the water recirculation system (1) also comprises another water treating unit in the form of a light unit (500).
15. The water recirculation system (1) according to any of the preceding claims, wherein the water recirculation system (1) also comprises another water treating unit which is a UV unit arranged subsequent to a an ozone treatment unit (1000).
16. The water recirculation system (1) according to claim 15, wherein a heating source (100) and a UV unit is arranged in a combined UV/heater unit.
17. The water recirculation system (1) according to any of the preceding claims, wherein the water recirculation system (1) also comprises another water purification unit in the form of a filter (600).
18. The water recirculation system (1) according to claim 17, wherein the ozone treatment unit (1000) is positioned after the filter (600).
19. The water recirculation system (1) according to claim 18, wherein the filter (600) is a ceramic filter which is the input unit for ozone being produced in the ozone reactor of the ozone treatment unit (1000).
20. The water recirculation system (1) according to any of the preceding claims, wherein the water recirculation system (1) also comprises a second heating source.
21. The water recirculation system (1) according to any of the preceding claims, wherein the point of separation (30) is arranged in a drain (300).
22. The water recirculation system (1) according to any of the preceding claims, wherein the sensor unit (7) comprises at least one conductivity sensor and/or at least one turbidity sensor.
23. Method for operation of a water recirculation system (1) comprising an ozone treatment unit (1000) according to any of the preceding claims, wherein a sequence of heating water in the water recirculation system (1) and a sequence of ozone treatment of water in the water recirculation system (1) are performed at different times.

### Clauses—a Sixth Aspect of the Present Invention

1. A water distribution system (1) comprising a water supply, a heating source (100) or a point of inflow of externally heated water, a sensor unit (7) with at least one sensor measuring water quality, an outflow path (150) for water with a user outflow (UO), and a control unit for operation of the water distribution system (1), said at least one sensor in measuring water quality being connected to the control unit, said water distribution system (1) being a water recirculation system intended for recycling of water or discarding of water not suitable to recycle, said water recirculation system comprising a flow path for recirculation (50), and wherein the sensor unit (7) is connected to the control unit which decides if water should be recycled or discarded in a point of separation (30) based on the measurement of the water quality, wherein a flow redirecting unit (10000) is arranged to enable to provide a closed loop of at least part of the outflow path (150) and the flow path for recirculation (50) and at which time a free outflow from the user outflow (UO) is disabled so that water cannot flow out from the user outflow (UO) the regular direction.
2. The water distribution system (1) according to claim 1, wherein the water distribution system (1) is a water recirculation system comprising at least one water treating unit (6), preferably a UV treating unit, more preferably a water treating system comprising both a filter unit and a UV treating unit, e.g. a filter unit and a combined UV treating unit and a heater.
3. The water distribution system (1) according to claim 1 or 2, wherein a stationary outflow unit (400) is the flow directing unit (10000) and comprises a direct recirculation flow direction to redirect the water flow from the user outflow (UO) and to direct recirculation.
4. The water distribution system (1) according to claim 1 or 2, wherein a stationary outflow unit (400) is a rotary unit with at least two positions, said stationary outflow unit therefore being the flow directing unit (10000), one first position being for regular user outflow and another position being in an at least partly rotated state and with direct recirculation mode.
5. The water distribution system (1) according to claim 1 or 2, wherein a stationary outflow unit (400) is a rotary unit with at least two positions, said stationary outflow unit therefore being the flow directing unit (10000), one first position being for regular user outflow and another position being pivoted downwards to dock into a docking unit (6000).
6. The water distribution system (1) according to claim 1 or 2, wherein the water distribution system comprises a docking unit (6000) into which a handheld outflow unit (401) is dockable, said handheld outflow unit (400) being the flow directing unit (10000), and wherein a dockable state provides a water flow connection between the handheld outflow unit (401) and the docking unit (6000) and provides a closed loop of at least part of the outflow path (150) and the flow path for recirculation (50) is established.
7. The water distribution system (1) according to claim 6, wherein a stationary outflow unit (400) is the docking station (6000).
8. The water distribution system (1) according to claim 1 or 2, wherein the flow redirecting unit (10000) is in the form of a connectable unit to connect the user outflow (UO) with the flow path for recirculation (50).
9. The water distribution system (1) according to claim 1 or 2, wherein the water distribution system (1) is a recirculating shower.
10. The water distribution system (1) according to any of claims 6-9, wherein the handheld outflow unit (401) is a handheld shower unit.
11. The water distribution system (1) according to claim 9 or 10, wherein the stationary outflow unit (400) is a top shower unit which is a docking unit (6000), and wherein the handheld outflow unit (401) is a handheld shower unit which is dockable into the docking unit (6000) for establishment of water flow connection.
12. The water distribution system (1) according to any of the preceding claims, which water distribution system (1) is a recirculating shower comprising a wall box comprising at least one water treating unit, and which wall box comprises a docking unit (6000) into which a handheld shower is dockable for establishment of water flow connection.

1. A water distribution system comprising:
a water supply,
a heating source or a point of inflow of externally heated water,
at least one sensor measuring water quality,
a flow path for water with a user outflow, and
a control unit for operation of the water distribution system, wherein:
said at least one sensor measuring water quality is being connected to the control unit,
the water distribution system comprises tubing in a tubing system, and
at least one portion of the tubing system in the water distribution system comprises a tubing portion which is made of a plastic material comprising silver and/or zinc to provide an inner anti-biofilm of that tubing portion.

2. The water distribution system according to claim 1, wherein said tubing portion is arranged along the flow path provided subsequent to the heating source or a point of inflow of externally heated water and towards the user outflow.

3. The water distribution system according to claim 1, wherein the tubing portion provided from the heating source or the point of inflow of externally heated water and along an entire length to the user outflow is made of a plastic material comprising silver and/or zinc to provide an inner anti-biofilm of that tubing portion.

4. The water distribution system according to claim 1, wherein different tubing portions of the tubing in the tubing system in the water distribution system are made of a plastic material comprising silver and/or zinc to provide an inner anti-biofilm of those tubing portions.

5. The water distribution system according to claim 1, wherein the plastic material comprises zinc to provide an inner anti-biofilm property.

6. The water distribution system according to claim 1, wherein the silver and/or zinc is extruded into the plastic material when the plastic material is produced.

7. The water distribution system according to claim 1, wherein the plastic material is polyamide, polyethylene, polypropylene, polyurethane or a combination thereof.

8. The water distribution system according to claim 1, wherein:
the water distribution system is a water recirculation system intended for recycling of water or discarding of water not suitable to recycle,
said water recirculation system includes a flow path for recirculation and a sensor unit arranged for measurement of at least water quality,
the sensor unit is connected to the control unit which decides if water should be recycled or discarded in a point of separation based on the measurement of the water quality and
the water recirculation system comprises at least one water treating unit.

9. The water distribution system according to claim 8, wherein the water recirculation system is a recirculating shower.

10. The water distribution system according to claim 9, wherein:
the recirculating shower comprises a wall box comprising at least one water treating unit, and
the tubing portion arranged from the wall box and towards a shower outflow is made of a plastic material comprising silver and/or zinc to provide an inner anti-biofilm of that tubing portion.

11. The water distribution system according to claim 9, wherein the tubing portion arranged from a shower valve and until a shower outflow is made of a plastic material comprising silver and/or zinc to provide an inner anti-biofilm of that tubing portion.

12. Use of tubing being made of a plastic material comprising silver and/or zinc to provide an inner anti-biofilm of at least one tubing portion of the tubing in a tubing system, for the provision of anti-fouling in that tubing portion, in a water recirculation system according to claim 1.
